(19) United States
(12) Patent Application Publication
(10) Pub. No.: US 2023/0160488 A1
(43) Pub. Date: May 25, 2023

(54) APPARATUS, PROCESSING DEVICE AND METHODS FOR RELIEVING PRESSURE AND SYSTEM HAVING THE APPARATUS

(71) Applicant: Ham-Let (Israel-Canada) Ltd, Nof Hagailil (IL)

(72) Inventors: Leng Keong Lee, Singapore (SG); Lei Shi, Singapore (SG); Sim Hau Lou, Johor Bahru (MY); Xiao Bin Yuan, Singapore (SG)

(21) Appl. No.: 17/908,522

(22) PCT Filed: Mar. 4, 2020
(86) PCT No.: PCT/SG2020/050099

§ 371 Date: Aug. 31, 2022

(51) Int. Cl. F16K 17/02; F16K 37/00

(52) U.S. Cl. CPC F16K 17/02; F16K 37/0091

(57) ABSTRACT

According to embodiments of the present invention, an apparatus is provided. The apparatus includes a relief valve having an inlet pathway arranged to receive a medium flowing in the apparatus, and an outlet pathway arranged for the medium from the inlet pathway to flow through at a relief state to relieve pressure in the apparatus, an outlet pressure sensor arranged to determine an outlet pressure associated with the outlet pathway, and a processing circuit configured to determine a status of the relief valve based on the outlet pressure.

### TECHNICAL FIELD

Various embodiments relate to an apparatus, a processing device and methods, for example, for relieving or releasing pressure, and a system having the apparatus.

### BACKGROUND

A relief valve is a type of safety valve used to control or limit the pressure in a system; pressure might otherwise build up and create a process upset, instrument or equipment failure, or fire. The pressure is relieved by allowing the pressurised fluid to flow from an auxiliary passage out of the system. The relief valve is designed or set to open at a predetermined set pressure to protect pressure vessels and other equipment from being subjected to pressures that exceed their design limits. Many of the relief valves are spring operated. The relief pre-set pressure is determined by the spring pressure. The relief valve's pre-set can be configured mechanically; it's very important to keep track of this pre-set value for maintenance purpose. However, the relief pressure might change over time after configuration due to spring deterioration, and it's very desirable to detect this condition. As the pressure increase beyond the pre-set pressure typically indicates an abnormal condition in the system, it's desirable to know when the relief happened so that the error condition can be analysed, and the system maintained. Depending on the type of media, it could also be valuable to know the relief flow rate and the flow volume.

Known approaches typically use separate meters and gauges to measure the pressure or flow; however, these meter/gauges must be read manually. A person is, therefore, required to manually observe or check whether there is relief, typically, using additional accessories that indicate flow, such as a flow meter or a wind wheel shaped indicator that turns with flow, etc., but this is not easy or practical. The applicable accessory depends on the relief media, and often has limitations in terms of capability. Known approaches generally allow relief to be determined, as described above, but do not provide other information. Further, given the bursting nature of the relief process, it's hard to get accurate readings manually.

### SUMMARY

The invention is defined in the independent claims. Further embodiments of the invention are defined in the dependent claims.

According to an embodiment, an apparatus is provided. The apparatus may include a relief valve having an inlet pathway arranged to receive a medium flowing in the apparatus, and an outlet pathway arranged for the medium from the inlet pathway to flow through at a relief state to relieve pressure in the apparatus, an outlet pressure sensor arranged to determine an outlet pressure associated with the outlet pathway, and a processing circuit configured to determine a status of the relief valve based on the outlet pressure.

According to an embodiment, a system is provided. The system may include the apparatus described herein having a transmitter, and a communications device communicatively coupled to the processing circuit of the apparatus to receive data indicative of a status of the relief valve.

According to an embodiment, a method is provided. The method may include determining an outlet pressure associated with an outlet pathway of a relief valve of an apparatus, the relief valve having an inlet pathway arranged to receive a medium flowing in the apparatus, and the outlet pathway arranged for the medium from the inlet pathway to flow through at a relief state to relieve pressure in the apparatus, and determining a status of the relief valve based on the outlet pressure.

According to an embodiment, a processing device is provided. The processing device may include a processor and a memory, the processing device being configured under control of the processor, to execute instructions in the memory to determine a status of a relief valve of an apparatus for relieving pressure based on an outlet pressure, wherein the relief valve has an inlet pathway arranged to receive a medium flowing in the apparatus, and an outlet pathway arranged for the medium from the inlet pathway to flow through at a relief state to relieve pressure in the apparatus, and wherein the outlet pressure is associated with the outlet pathway.

According to an embodiment, a method is provided. The method may include determining a status of a relief valve of an apparatus for relieving pressure based on an outlet pressure, wherein the relief valve has an inlet pathway arranged to receive a medium flowing in the apparatus, and an outlet pathway arranged for the medium from the inlet pathway to flow through at a relief state to relieve pressure in the apparatus, and wherein the outlet pressure is associated with the outlet pathway.

According to an embodiment, a computer program or a computer program product is provided. The computer program or a computer program product may include instructions for implementing one or more of the methods described herein.

According to an embodiment, a non-transitory storage medium is provided. The non-transitory storage medium may store instructions, which when executed by a processor cause the processor to perform one or more of the methods described herein.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic view of an apparatus according to various embodiments.

FIG. 1B shows a schematic view of a system according to various embodiments.

FIG. 1C shows a flow chart illustrating a method according to various embodiments.

FIG. 1D shows a schematic view of a processing device according to various embodiments.

FIG. 1E shows a method according to various embodiments.

FIG. 2 shows a schematic diagram illustrating a smart relief valve and the components thereof, according to various embodiments.

FIGS. 3A and 3B show schematic diagrams illustrating a smart relief valve at a non-relief state and at a relief state, respectively, according to various embodiments.

FIG. 4 shows a schematic diagram illustrating an overview of a system having the smart relief valve of various embodiments.

FIG. 5A shows a schematic diagram of a model for flow rate calculation.

FIG. 5B shows an example of the flow rate and flow volume results.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide a smart relief valve IoT (Internet of Things) system. For example, various embodiments may relates to adding IoT functionality to the relief valve to allow preventive maintenance and enable better safety for the valve.

Various embodiments may provide a system that may address one or more of the following needs for the relief valve.

1. Detection of relief action (valve on/off state);

2. Detection of spring deterioration and non-indication of relief at pre-set (using inlet and outlet pressure measurements);

3. Pre-set pressure real time adjustment (using inlet pressure reading);

4. Measurement of outlet pressure and calculation of relief flow rate and relief flow volume.

Various embodiments may provide a smart relief valve having a relief valve (e.g., spring-operated valve), inlet and outlet pressure sensors coupled to the valve body, and a smart valve board (with software) communicatively coupled to the pressure sensors that processes the pressure data/measurements and enables the IoT capability and the smart features in the smart relief valve. The smart relief valve may be useful in various applications that may allow at least one of detection of activation of the relief valve, detection of certain undesirable events that may require maintenance work on the relief valve, adjustment of the relief valve, or calculation of relief flow rate and relief flow volume on the basis of the pressure readings by the inlet and/or outlet pressure sensors. By determining the outlet pressure, the state of the relief valve may be determined. By determining the inlet pressure at the point of relief, real-time calibration of the pre-set pressure of the relief valve may be done, and the user may be notified if the relief pressure measured is lower than the pre-set pressure, and/or if relief is not detected (e.g., outlet pressure remains at atmospheric pressure or at zero relative to atmospheric pressure) even when the inlet pressure is determined to have reached the pre-set pressure or beyond. When the relief valve is activated, the relief flow rate and the relief flow volume of medium or fluid out of the system may be determined based on, among others, the inlet pressure and the outlet pressure. The smart relief valve may also include a temperature sensor for temperature sensing for determination of the relief flow rate and the relief flow volume.

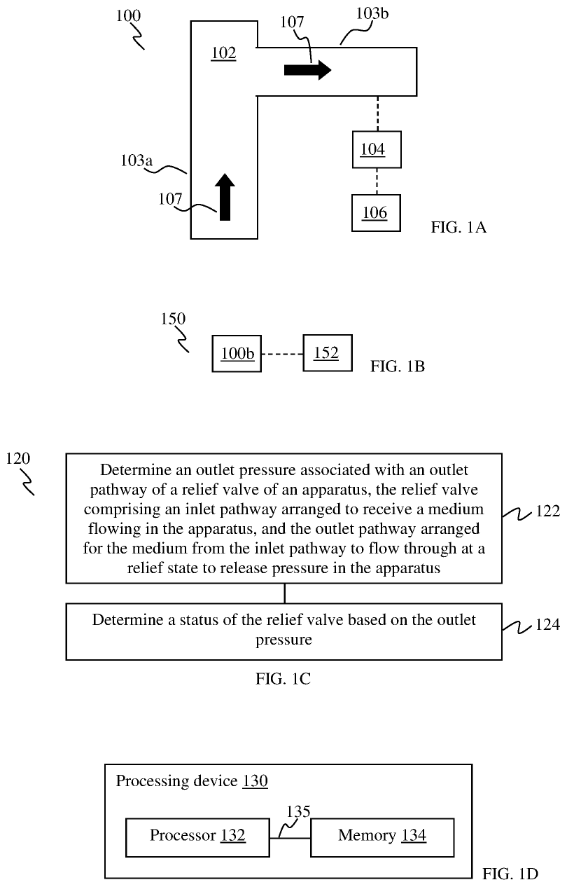

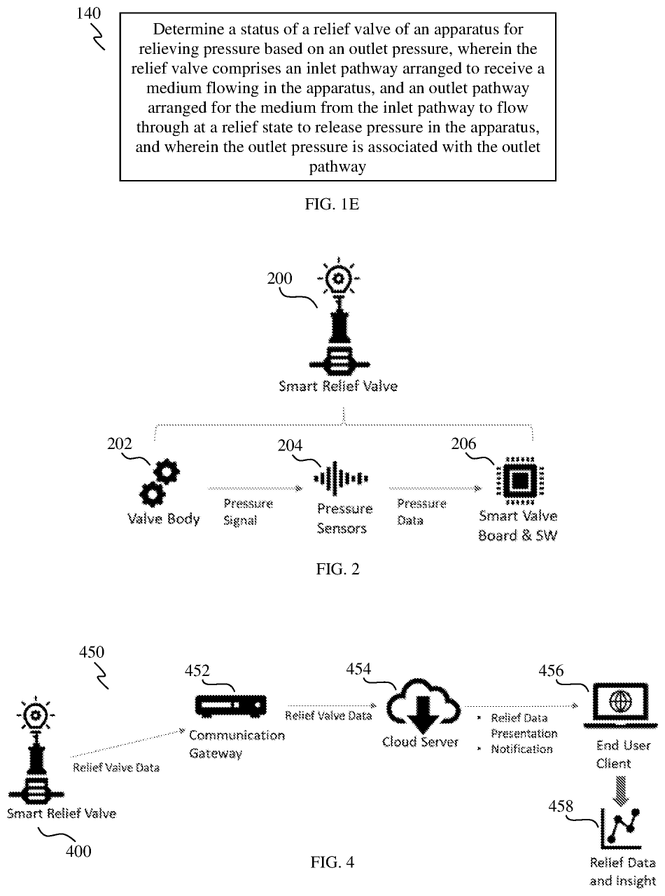

FIG. 1A shows a schematic view of an apparatus 100 according to various embodiments. The apparatus 100 may be for relieving (or releasing) pressure and/or determining a status of a relief valve of the apparatus 100.

The apparatus 100 includes a relief valve 102 having an inlet pathway 103a arranged to receive a medium (represented by the arrow 107) flowing in the apparatus 100, and an outlet pathway 103b arranged for the medium 107 from the inlet pathway 103a to flow through at a relief state to relieve the pressure in the apparatus 100, an outlet pressure sensor 104a arranged to determine an outlet pressure associated with the outlet pathway 103b, and a processing circuit 106 configured to determine a status of the relief valve 102 based on the outlet pressure.

In other words, an apparatus 100 having a relief valve 102 may be provided. The relief valve 102 may have a valve body. A medium 107 may be received by the apparatus 100 to flow through the apparatus 100. There may be more than one medium flowing in the apparatus 100. The relief valve 102 may help to release or relieve pressure, for example, when there may be excess pressure built up in the apparatus 100. The relief valve 102 may have an inlet pathway (or passageway) 103a arranged to receive the medium 107 flowing in the apparatus 100, an outlet pathway (or passageway) 103b (or relief pathway) arranged for the medium 107 (or part thereof) from the inlet pathway 103a to flow through at a relief state to relieve the pressure in the apparatus 100. At the relief state, for example, the outlet pathway 103b may allow the medium 107 to escape and to flow out of the apparatus 100. Accordingly, the medium 107 may flow into the relief valve 102 through the inlet pathway 103a, and, at the relief state, the medium 107 may flow out of the relief valve 102 and/or the apparatus 100 through the outlet pathway 103b. The outlet pathway 103b may lead out of the apparatus 100 or system having the apparatus 100, or there may be a channel or conduit (e.g., a tube or pipe) in fluid communication with or coupled to the outlet pathway 103b, for the medium 107 to flow out of the apparatus 100 or the system.

The “relief state” refers to the state or condition where the relief valve 102 is “ON” or activated or in an open state to relief any pressure built-up in the relief valve 102 (or the apparatus 100). At the non-relief state, there is a mechanism (e.g., spring mechanism) (not shown) in the relief valve 102 that obstructs or blocks flow of the medium 107 from the inlet pathway 103a to the outlet pathway 103b. At the relief state, the mechanism may be operable to allow fluid communication between the outlet pathway 103b and the inlet pathway 103a to allow flow of the medium 107 from the inlet pathway 103a to the outlet pathway 103b.

The apparatus 100 may further include an outlet pressure sensor 104 arranged to determine or measure an outlet pressure associated with (or at) the outlet pathway 103b. The outlet pressure sensor 104 may be coupled or connected to the outlet pathway 103b, for example, using one or more fittings. The outlet pressure may include the pressure of the medium 107 at the outlet pathway 103b at the relief state. The outlet pressure is generally at atmospheric pressure or zero (relative to atmospheric pressure) when the relief valve 102 is not at the relief state (i.e., at non-relief state), while, at the relief state, the outlet pressure is above atmospheric pressure or above zero (relative to atmospheric pressure).

The apparatus 100 may further include a processing circuit 106 to determine a status (or condition) of the relief valve 102 based on the outlet pressure. The processing circuit 106 may be communicatively coupled to the outlet pressure sensor 104. The processing circuit 106 may be electrically coupled to the outlet pressure sensor 104, e.g., by means of one or more wires.

In the context of various embodiments, the medium 107 may be a fluid, for example, at least one of a liquid or a gas.

In the context of various embodiments, the apparatus 100 may be a smart relief valve or a (smart) relief valve arrangement.

The apparatus 100 may further include an inlet pressure sensor arranged to determine an inlet pressure associated with (or at) the inlet pathway 103a, and the processing circuit 106 may determine the status of the relief valve 102 based on the outlet pressure and the inlet pressure. The inlet pressure sensor may be coupled or connected to the inlet pathway 103a, for example, using one or more fittings. The inlet pressure may include the pressure of the medium 107 at the inlet pathway 103a at any time. The processing circuit 106 may also be communicatively coupled to the inlet pressure sensor. The processing circuit 106 may be electrically coupled to the inlet pressure sensor, e.g., by means of one or more wires.

In various embodiments, in response to determination that the outlet pressure is higher than a non-relief pressure associated with the outlet pathway at a non-relief state, the processing circuit 106 may determine that the relief valve 102 is at the relief state as the status of the relief valve 102. In other words, the relief valve 102 may be determined to be “ON” or activated or in an open state. The processing circuit 106 may determine that the relief valve 102 is at the relief state as the status of the relief valve 102 in response to determination that the outlet pressure is higher than the non-relief pressure and determination that the inlet pressure is equal to or more than a defined (or pre-set) pressure (or relief pressure) corresponding to the relief state.

In the context of various embodiments, the non-relief pressure associated with the outlet pathway at the non-relief state (or “non-relief outlet pressure”) may mean the atmospheric pressure, or zero pressure relative to the atmospheric pressure.

In the context of various embodiments, the outlet pressure determined by the outlet pressure sensor 104a may be an absolute pressure, or a differential pressure relative to the non-relief outlet pressure such as atmospheric pressure.

Further, in response to determination that the outlet pressure is substantially same as a non-relief pressure associated with the outlet pathway at a non-relief state, the processing circuit 106 may determine that the relief valve 102 is not at the relief state as the status of the relief valve 102. In other words, the relief valve 102 may be determined to be “OFF” or not activated or in a closed state.

The relief valve 102 may have a defined (or pre-set) pressure (or also known as relief pressure) corresponding to the relief state, and, in response to determination that the outlet pressure is higher than a non-relief pressure associated with the outlet pathway at a non-relief state and determination that the inlet pressure is less than the defined pressure, the processing circuit 106 may determine that there is an anomaly in the relief valve 102 as the status of the relief valve 102. The anomaly may correspond to deterioration of the relief valve 102. Being aware of the anomaly may prompt a user to perform maintenance work, e.g., to recalibrate the relief valve 102 (or the defined pressure), or replace the relief valve 102.

The relief valve 102 may have a defined (or pre-set) pressure (or also known as relief pressure) corresponding to the relief state, and, in response to determination that the outlet pressure is substantially same as a non-relief pressure associated with the outlet pathway at a non-relief state and determination that the inlet pressure is equal to or more than the defined pressure, the processing circuit 106 may determine that there is an anomaly in the relief valve 102 as the status of the relief valve 102. The anomaly may correspond to non-indication of relief. Being aware of the anomaly may prompt a user to perform maintenance work.

The apparatus 100 may further include a constricted section to moderate (or impede or slow) the flow of the medium 107 in the outlet pathway 103b for the outlet pressure sensor 104 to determine the outlet pressure at the relief state. The constricted section may be provided downstream of the outlet pressure sensor 104, meaning that the medium 107 in the outlet pathway 103b may flow in a direction from the outlet pressure sensor 104 to the constricted section. The constricted section may be provided at or as part of the outlet pathway 103b.

The apparatus 100 may further include a temperature sensor arranged to determine a temperature associated with (or at) the inlet pathway 103a. The temperature may refer to the temperature of the medium 107 at the inlet pathway 103a. The temperature sensor may be part of the inlet pressure sensor or may be a separate sensor.

In various embodiments, the processing circuit 106 may determine a time of occurrence of the relief state, e.g., the time when the outlet pressure associated with the outlet pathway 103b goes higher than the non-relief pressure associated with the outlet pathway at a non-relief state.

The processing circuit 106 may further determine a flow rate of the medium 107 flowing through the outlet pathway 103b at the relief state. The flow rate may be determined, based at least in part, on the inlet and outlet pressures determined at the relief state. Other parameters for determining the flow rate may include the density of the medium 107, which may change with temperature, and the dimensions of the valve body of the relief valve 102. The density of the medium 107 may be determined at the temperature determined using a temperature sensor associated with (or at) the inlet pathway 103a.

The processing circuit 106 may, based on the determined flow rate, determine a flow volume of the medium 107 flowing through the outlet pathway 103b.

The processing circuit 106 may further include a transmitter to transmit data indicative of the status of the relief valve 102, e.g., to a communication device, a gateway, or a server. The transmitter may further transmit at least one of data representative of the inlet pressure or data representative of the outlet pressure. The processing circuit 106 may include a transceiver having the transmitter. The processing circuit 106 may include at least one transceiver, e.g., a wired transceiver and/or a wireless transceiver.

In the context of various embodiments, the relief valve 102 may be or may include a spring-operated relief valve.

FIG. 1B shows a schematic view of a system 150 according to various embodiments. The system 150 includes an apparatus 100b, and a communications device 152 communicatively coupled to the processing circuit (e.g., 106, FIG. 1A) of the apparatus 100b to receive the data indicative of the status of the relief valve (e.g., 102, FIG. 1A). The apparatus 100b may be as described in the context of the apparatus 100 having a processing circuit 106 with a transmitter. The communications device 152 may further receive at least one of data representative of the inlet pressure or data representative of the outlet pressure from the processing circuit. The communications device 152 may include at least one transceiver, e.g., a wired transceiver and/or a wireless transceiver. Communication between the processing circuit and the communications device 152 may be by means of wired and/or wireless communication. There may be two-way communication between the processing circuit and the communications device 152. The communications device 152 may transmit at least one of the data representative of the inlet pressure, the data representative of the outlet pressur or the data indicative of the status of the relief valve for receipt by a user communications device.

The communications device 152 may be or may include at least one of a communication gateway or a server apparatus. The server apparatus may be cloud-based. In various embodiments, a communication gateway and a server apparatus may be separately provided in the system 150. The communication gateway may be communicatively coupled to the processing circuit and the server apparatus may be communicatively coupled to the communication gateway.

The communications device 152 may, based on the data indicative of the status of the relief valve, generate a notification corresponding to the status, and transmit the notification to a user communications device.

In the context of various embodiments, a user communications device may include a workstation, a desktop, a laptop, a mobile phone, a tablet device, etc.

The system 150 may include a plurality of apparatus 100b. For each apparatus 100b, the communications device 152 may be communicatively coupled to the processing circuit of the apparatus 100b.

FIG. 1C shows a flow chart 120 illustrating a method according to various embodiments.

At 122, an outlet pressure associated with an outlet pathway of a relief valve of an apparatus is determined, the relief valve having an inlet pathway arranged to receive a medium flowing in the apparatus, and the outlet pathway arranged for the medium from the inlet pathway to flow through at a relief state to relieve pressure in the apparatus.

At 124, a status of the relief valve is determined based on the outlet pressure.

The method may further include determining an inlet pressure associated with the inlet pathway, and, at 124, the status of the relief valve may be determined based on the outlet pressure and the inlet pressure.

In various embodiments, in response to determination that the pressure is higher than a non-relief pressure associated with the outlet pathway at a non-relief state, at 124, the relief valve may be determined to be at the relief state as the status.

In various embodiments, in response to determination that the outlet pressure is higher than a non-relief pressure associated with the outlet pathway at a non-relief state and determination that the inlet pressure is less than a defined pressure corresponding to the relief state, at 124, an anomaly in the relief valve may be determined as the status.

In various embodiments, in response to determination that the outlet pressure is substantially same as a non-relief pressure associated with the outlet pathway at a non-relief state and determination that the inlet pressure is equal to or more than a defined pressure corresponding to the relief state, at 124, an anomaly in the relief valve may be determined as the status.

The method may further include moderating the flow of the medium in the outlet pathway for determining the outlet pressure at the relief state.

The method may further include determining a temperature associated with the inlet pathway.

The method may further include determining a time of occurrence of the relief state.

The method may further include determining a flow rate of the medium flowing through the outlet pathway at the relief state.

The method may further include determining, based on the determined flow rate, a flow volume of the medium flowing through the outlet pathway.

The method may further include transmitting data indicative of the status of the relief valve.

FIG. 1D shows a schematic view of a processing device 130 according to various embodiments. The processing device 130 includes a processor 132 and a memory 134, the processing device 130 being configured under control of the processor 132, to execute instructions in the memory 134 to determine a status of a relief valve of an apparatus for relieving pressure based on an outlet pressure, wherein the relief valve includes an inlet pathway arranged to receive a medium flowing in the apparatus, and an outlet pathway arranged for the medium from the inlet pathway to flow through at a relief state to relieve pressure in the apparatus, and wherein the outlet pressure is associated with the outlet pathway. The processor 132 and the memory 134 may be coupled to each other (as represented by the line 135), e.g., physically coupled and/or electrically coupled.

For determining the status of the relief valve, the processing device 130 may determine the status of the relief valve based on the outlet pressure and an inlet pressure associated with the inlet pathway.

In response to determination that the outlet pressure is higher than a non-relief pressure associated with the outlet pathway at a non-relief state, the processing device 130 may determine that the relief valve is at the relief state as the status of the relief valve.

The relief valve may have a defined pressure (or also known as relief pressure) corresponding to the relief state, and, in response to determination that the outlet pressure is higher than a non-relief pressure associated with the outlet pathway at a non-relief state and determination that the inlet pressure is less than the defined pressure, the processing device 130 may determine that there is an anomaly in the relief valve as the status of the relief valve.

The relief valve may have a defined pressure (or also known as relief pressure) corresponding to the relief state, and, in response to determination that the outlet pressure is substantially same as a non-relief pressure associated with the outlet pathway at a non-relief state and determination that the inlet pressure is equal to or more than the defined pressure, the processing device 130 may determine that there is an anomaly in the relief valve as the status of the relief valve.

The processing device 130 may further transmit data indicative of the status of the relief valve.

FIG. 1E shows a method 140 according to various embodiments. The method 140 includes determining a status of a relief valve of an apparatus for relieving pressure based on an outlet pressure, wherein the relief valve includes an inlet pathway arranged to receive a medium flowing in the apparatus, and an outlet pathway arranged for the medium from the inlet pathway to flow through at a relief state to relieve pressure in the apparatus, and wherein the outlet pressure is associated with the outlet pathway.

The method 140 may determine the status of the relief valve based on the outlet pressure and an inlet pressure associated with the inlet pathway.

In response to determination that the outlet pressure is higher than a non-relief pressure associated with the outlet pathway at a non-relief state, the method 140 may determine that the relief valve is at the relief state as the status.

In response to determination that the outlet pressure is higher than a non-relief pressure associated with the outlet pathway at a non-relief state and determination that the inlet pressure is less than a defined pressure corresponding to the relief state, the method 140 may determine that there is an anomaly in the relief valve as the status.

In response to determination that the outlet pressure is substantially same as a non-relief pressure associated with the outlet pathway at a non-relief state and determination that the inlet pressure is equal to or more than a defined pressure corresponding to the relief state, the method 140 may determine that there is an anomaly in the relief valve as the status.

The method 140 may further include transmitting data indicative of the status of the relief valve.

There may also be provided a computer program product having instructions for implementing one or more of the methods described herein.

There may also be provided a computer program having instructions for implementing one or more of the methods described herein.

There may further be provided a non-transitory storage medium storing instructions, which, when executed by a processor, cause the processor to perform one or more of the methods described herein.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

It should be appreciated that description in the context of any one of the apparatus 100, system 150, method 120, processing device 130, and method 140 may correspondingly be applicable in relation to any one of the others described herein.

Various embodiments may provide a smart relief valve having a relief valve (e.g., spring-operated valve) having a valve body, inlet and outlet pressure sensors coupled to the valve body, and a smart valve board (with software) communicatively coupled to the pressure sensors. The smart valve board may process the pressure data/measurements and may enable the IoT (Internet of Things) capability and the smart features in the smart relief valve, and may further enable onward communication/transmission of valve data, e.g., to a server or a cloud platform, which may subsequently be provided to a user/operator of the smart relief valve. The smart valve board may be connected to the pressure sensors by wires, and may communicate with the communication gateway via wired or wireless communication. There may also be provided a temperature sensor, either as a separate sensor or as part of the inlet pressure sensor, for temperature sensing which may be useful for determination of the relief flow rate and relief flow volume of fluid out of the system when the relief valve is activated.

The smart relief valve may be useful in one or more applications, including, but not limited to, (i) detection of relief action (valve on/off state), (ii) detection of spring deterioration and non-indication of relief at pre-set pressure, (iii) pre-set pressure real time adjustment, and (iv) measurement of outlet pressure and calculation of relief flow rate and relief flow volume. A user may be presented with valve data that may be indicative of the occurrence of one or more of the above-mentioned events, and/or information that may allow the user to make an informed decision on whether there is a need to take certain actions, e.g., maintenance and valve replacement, tuning/adjusting the relief pre-set pressure, etc. Notifications may also be sent to the user when certain conditions/preferences are met so as to, e.g., warn the user of a specific undesirable event.

In operation, the inlet pressure may be measured by the inlet pressure sensor and sent to the smart valve board for processing, which may be useful for enabling real time calibration of the relief pressure. The outlet pressure may be measured by the outlet pressure sensor and sent to the smart valve board for processing, where the outlet pressure is normally at atmospheric pressure or zero (relative to atmospheric pressure) when there is no relief (i.e., relief valve is not activated), and greater than atmospheric pressure or greater than zero (relative to atmospheric pressure) when the relief valve is activated to reduce pressure in the system. The outlet direction of the relief valve may be connected to open air, and a constricted section or pathway may be provided after the outlet pressure sensor to trap the outlet pressure, at least temporarily, for it to be measured, before the pressure at the outlet balances to the atmospheric pressure level of open air.

By determining the outlet pressure, the state of the relief valve (i.e., open state or close state) may be detected. Accordingly, the relief status and the relief timing may be determined.

The inlet pressure measurement at the point of relief (i.e., when the relief valve is activated or on, and the outlet pressure goes above the pressure associated with the outlet pathway at a non-relief state) is the “relief pressure”, which generally corresponds to the “pre-set pressure” of the relief valve. The relief pressure may be set or adjusted mechanically, by adjusting the relief valve spring to the desired relief pressure/pre-set pressure. It is possible that the relief pressure might change over time (i.e., differs from the pre-set pressure) where such a change may be indicative of an abnormal condition and, therefore, it is desirable to be able to detect such a condition.

With the use of the smart relief valve, the inlet pressure may be measured at which relief occurs, and such data may be helpful to (i) allow real-time calibration of the pre-set pressure to the desired relief pressure, and/or (ii) notify the user of the need for maintenance when the relief pressure measured is lower than the pre-set pressure which may be indicative of a deterioration in the spring of the relief valve (thereby causing a drop in the pressure exerted by the spring) resulting in relief occurring at a lower pressure than that of the pre-set pressure, and/or (iii) notify the user of the need for maintenance when relief is not detected (i.e., outlet pressure remains at the non-relief outlet pressure) even when the inlet pressure is determined to have reached the pre-set pressure or beyond.

When the relief valve is activated, at least one of the relief flow rate and the relief flow volume may be determined based on the inlet pressure, outlet pressure, density of the fluid, and dimensions of the relief valve body. This may be helpful for the determination of the amount of material released from the system, in particular for system/environmental safety concerns when the material within the valve may be hazardous.

Various embodiments or techniques will now be further described in detail, with reference to the drawings.

FIG. 2 shows a schematic diagram illustrating a smart relief valve 200 and the components thereof, according to various embodiments. The smart relief valve 200 may have smart capability or IoT functionality. The smart relief valve 200 may include a relief valve with a valve body 202, pressure sensors 204, and a processing circuit (e.g., a circuit board with software) 206. Pressure signal in the relief valve or valve body 202 may be detected with or by the pressure sensors 204. In turn, pressure data from the pressure sensors 204 may be provided (or transmitted) to or received by the processing circuit 206.

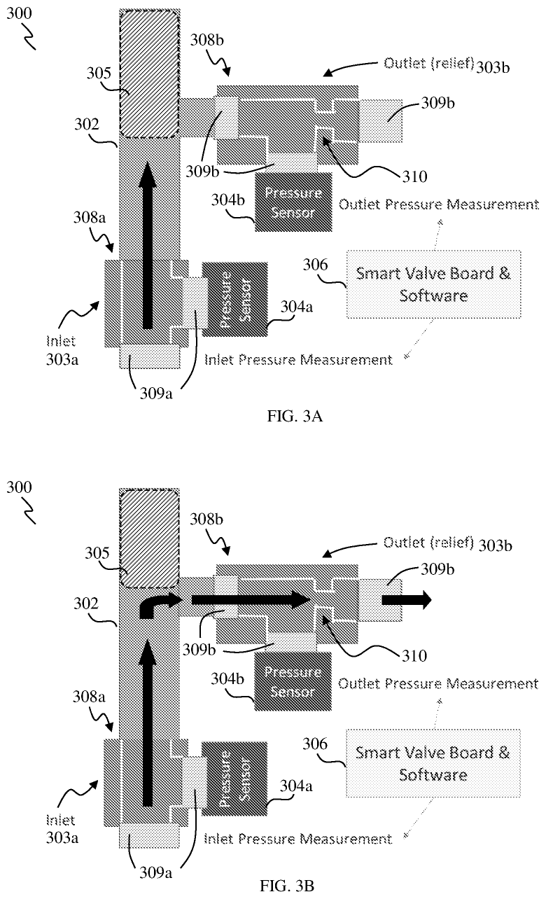

FIGS. 3A and 3B show schematic diagrams illustrating a smart relief valve 300 at a non-relief state and at a relief state, respectively. The smart relief valve (or relief valve arrangement) 300 may be similar to the smart relief valve 200. The smart relief valve 300 has a relief valve or valve body 302 having an inlet pathway 303a and an outlet pathway 303b, a first (inlet) pressure sensor 304a in communication with or coupled to the valve body 302, and a second (outlet) pressure sensor 304b in communication with or coupled to the valve body 302. A medium or fluid (liquid and/or gas) (represented by solid arrows) may flow in or through the relief valve or valve body 302.

There may be a mechanism 305 provided that may control flow of the medium from the inlet pathway 303a to the outlet pathway 303b. As shown in FIG. 3A, at a non-relief state, the mechanism 305 may prevent or block flow of the medium from the inlet pathway 303a to the outlet pathway 303b. At a relief state, as shown in FIG. 3B, when there is excess pressure, the mechanism 305 may be activated (e.g., the mechanism 305 or part thereof may be displaced) to allow fluid communication between the inlet pathway 303a and the outlet pathway 303b for the medium to flow from the inlet pathway 303a to the outlet pathway 303b. The medium may flow out of the system, into open air. In various embodiments, each of the relief valves 202, 302 may be a spring-operated relief valve, meaning that the mechanism 205 may include a spring mechanism. The spring-operated relief mechanism of the relief valve is mechanical in nature, with no electric power or actuator being involved.

The inlet pressure sensor 304a may be arranged to measure or sense an inlet pressure at an inlet pathway 303a of the relief valve 302. A first coupling section 308a may be provided for coupling or connecting the inlet pressure sensor 304a to a first part of the valve body 302 along an inlet pathway 303a of the valve body 302. The first coupling section 308a may include one or more mechanical fittings 309a.

The outlet pressure sensor 304b may be arranged to measure or sense an outlet pressure at an outlet pathway 303b of the relief valve 302. A second coupling section 308b may be provided for coupling or connecting the outlet pressure sensor 304b to a second part of the valve body 302 along an outlet (or relief) pathway 303b of the valve body 302. When the relief valve 302 is activated to relieve pressure, the outlet or relief pathway 303b may open to ambient pressure or open air. The second coupling section 308b may include one or more mechanical fittings 309b.

A narrow or constricted section 310 may be provided at the outlet pathway 303b, for example, as part of the coupling section 308b, or in a pipe at the outlet pathway 303b. The constricted section 310 may be provided after or downstream of the outlet pressure sensor 304b. The constricted section 310 may enable pressure at the outlet pathway 303b to be measured by the outlet pressure sensor 304b during release of the medium, and therefore, also the pressure, through the outlet pathway 303b. For example, when activated, the pressure at the outlet pathway 303b may equalise or balanced to ambient pressure (or atmosphere pressure level) in a short time as the pressure is released into open air, which may make it challenging to measure the original pressure before the balancing happens. In order for the outlet pressure sensor 304b to measure the pressure at the outlet pathway 303b consistently, the pressure therein needs to be stable. The constricted section 310 may, because of the narrower pathway, help to maintain the pressure in the outlet pathway 303b, at least temporarily, for the outlet pressure sensor 304b to measure the pressure, prior to equalisation to ambient pressure. The constricted section 310 may let the outlet pipe form a tank-like structure, to function like a sampling cylinder to trap the pressure inside for measurement. The constricted section 310 may act as a reducer to slow down the process that the pressure balances to atmosphere pressure level so that the outlet pressure sensor 304b may be able to measure the pressure. Therefore, there may be provided a mechanical design, in the form of the contricted section 310, that may enable the measurement of outlet pressure in a relief valve structure.

A processing circuit 306 (e.g., a circuit board, with software that runs on it) may be provided to be communicatively coupled to the inlet pressure sensor 304a and the outlet pressure sensor 304b. The processing circuit 306 may receive signals or data indicative or representative of the pressures detected by the inlet pressure sensor 304a and the outlet pressure sensor 304b. The processing circuit 306 may process the pressure measurements and, further, may enable the IoT capability and the smart features in the system. The processing circuit 306 may communicate with a communication gateway (e.g., an IoT gateway) and a cloud service (e.g., with a cloud server) to send out valve data and notifications, as will be described below. The processing circuit 306 may also support local communication protocol, which may allow local configuration and control.

The processing circuit 306 may sample the pressure readings from the pressure sensors 304a, 304b continuously or all the time, even when relief is not activated. The relief state (whether relief is activated) may be deduced from the pressure readings by the software running on the processing circuit 306. The processing circuit 306 may also collect data from other sensors, such as a temperature sensor.

The processing circuit 306 may be or may include a printed circuit board with processor and peripherals, and there is software running on it. The pressure sensors 304a, 304b may, for example, be connected to the processing circuit 306 with wires. Multiple wired hardware interfaces (such as I2C (Inter-Integrated Circuit), SPI (Serial Peripheral Interface)) may be supported by the processing circuit 306 to support different types of pressure sensors.

The inlet pressure sensor 304a and/or the outlet pressure sensor 304b may be an analogue sensor or a digital sensor. For a digital sensor, different electrical interfaces, such as I2C or SPI may be used. Different protocols or algorithms may be provided to calculate the actual sensor readings. The processing circuit 306 (e.g., PCB design) may cater for both analogue and digital sensors, and also for multiple electrical interfaces. The software running on the processing circuit 306 may support different protocols, while also providing flexibiliy to support new/additional protocols with the capability to perform firmware upgrade.

In various embodiments, each of the relief valves 202, 302 may, for example, be a high pressure relief valve.

Each of the smart relief valves 200, 300 may be as described in the context of the apparatus 100.

FIG. 4 shows a schematic diagram illustrating an overview of a system 450 having the smart relief valve 400 of various embodiments. The smart relief valve 400 may be as described in the context of any one of the apparatus 100 and smart relief valves 200, 300. While one smart relief valve 400 is shown in FIG. 4, it should be appreciated that a plurality of smart relief valves may be provided in the system 450.

The system 450 may be an IoT system, which may include the smart relief valve 400, a communication gateway 452 and a cloud server 454. The communication gateway 452 may be communicatively coupled to the smart relief valve 400 and the cloud server 454. The smart relief valve 400 may transmit relief valve data to the communication gateway 452. The communication gateway 452 may then transmit, to the cloud server 454, part of or all of the relief valve data received from the smart relief valve 400. The relief valve data may include raw data (e.g., pressure signals as measured by the pressure sensors of the relief valve 400) and/or data processed by the processing circuit of the relief valve 400.

In various embodiments, the communication gateway 452 may be a hub that may communicate with one or more smart relief valves and collect measurements and calculations therefrom. The gateway 452 may then send this information to the cloud server 454 which may provide data presentation and user notifications. For example, a user or client 456 may access the cloud server 454 to receive relief data presentation and notifications. The cloud server 454 may present the data from the smart relief valve(s) in the form of a web site and may allow the user 456 to see the relief data of the valve(s) (e.g., in the form of a graph 458), including if/when the relief happened, the relief flow rate and volume, whether any spring deterioration or non-indication of relief at pre-set is detected. Based on such information, the user can make informed decision(s) on maintenance and/or valve replacement. The cloud server 454 may also send notifications (e.g., email, SMS, etc.) to the user based on user configured conditions and preferences. The user may also perform tuning/adjustment of the relief pre-set pressure accurately from the cloud.

The transmission of data from the smart relief valve 400 to the gateway 452 may be wired or wireless, where both modes may be supported. The processing circuit of the smart relief valve 400 and the gateway 452 may include wired and/or wireless transceivers to support communication therebetween. For example, this may include Ethernet for wired communication and LoRa (Long Range low power technology) for wireless communication. Nevertheless, it should be appreciated that other communication protocols may be used.

The smart relief valve of various embodiments may provide one or more of the following features.

Inlet Pressure Measurement

The inlet pressure is measured by the input pressure sensor (e.g., 304a, FIG. 3), and the data may be sent to the processing circuit (e.g., smart valve board and software 306, FIG. 3) for processing. The inlet pressure measures the pressure of the medium or media (e.g., fluid(s)) in the system and may enable real time calibration of the relief pressure.

Outlet Pressure Measurement

The outlet pressure is measured by the outlet pressure sensor (e.g., 304b, FIG. 3), and the data may be sent to the processing circuit (e.g., smart valve board and software 306, FIG. 3) for processing. The outlet pressure is normally at the non-relief outlet pressure (e.g., atmospheric pressure) when no relief is happening. When there is relief, the outlet pressure is bigger than the non-relief outlet pressure. A constricted section (or aperture) (e.g., 310, FIG. 3) is created at the valve outlet after the outlet pressure sensor measurement point to capture the pressure for measurement.

Temperature Measurement

The inlet pressure sensor (e.g., 304a, FIG. 3) may also be capable of measuring temperature, and the data may be sent to the processing circuit (e.g., smart valve board and software 306, FIG. 3) for processing. For example, the the sensor may be a combination of pressure and temperature sensor. Alternatively, a temperature sensor (not shown), separate from the inlet pressure sensor, may be provided to measure temperature. The measured (inlet) temperature may be useful for determining the fluid density for flow rate calculation.

Relief (Valve Open/Close State) Detection

The techniques disclosed herein may enable (electrical/digital) detection of valve open/close state. The relief valve is normally closed, and the outlet pressure is at the non-relief outlet pressure (e.g., zero relative to atmospheric pressure). When the outlet pressure goes above the non-relief outlet pressure, the relief valve open state is detected. When the outlet pressure drops back to the non-relief outlet pressure, the relief valve close state is detected.

Pre-Set Pressure Measurement and Adjustment

The inlet pressure measurement at the point of relief (when outlet pressure goes above the non-relief outlet pressure) is the relief pressure (or pre-set pressure). The relief pre-set pressure may be set or adjusted through a calibration process. As non-limiting examples, the steps may include:

Adjusting the relief valve spring to the desired relief pressure.

Starting the calibration from cloud UI/local communication link, the valve enters calibration mode and may not report the readings collected during calibration. The calibration process ends either when relief is detected or when the process times out.

Pumping in the fluid to the relief valve input and increasing the pressure gradually, until relief happens. The valve reports the measured pressure at relief, this being the pre-set pressure value.

Comparing the expected relief pressure based on spring setting with the measured pressure pre-set. If they match, calibration is done. If they don't match, the spring is adjusted and calibration is performed again.

Detection of Spring Deterioration

When the spring (of the relief valve) deteriorates and has its pressure dropped, relief generally happens earlier, before the pressure reaches the pre-set pressure or relief pressure. When this happens, the inlet pressure measurement is lower than the pre-set pressure. The relief valve may detect this condition and send a notification for maintenance.

Non-Indication of Relief at Pre-Set Pressure

The opposite failure mode to spring deterioration is that relief is not detected, for example, the measured outlet pressure remains at the non-relief outlet pressure when the inlet pressure has reached the pre-set pressure. The relief valve may also detect this condition and send a notification for maintenance.

Calculation of Relief Flow Rate

The relief valve may calculate relief flow rate based on the inlet and outlet pressure measurements. This may, for example, be achieved using a trained model. Parameters that may impact the determination of flow rate may include the inlet pressure P1, outlet pressure P2, fluid density ρ, and the dimensions of the relief valve body.

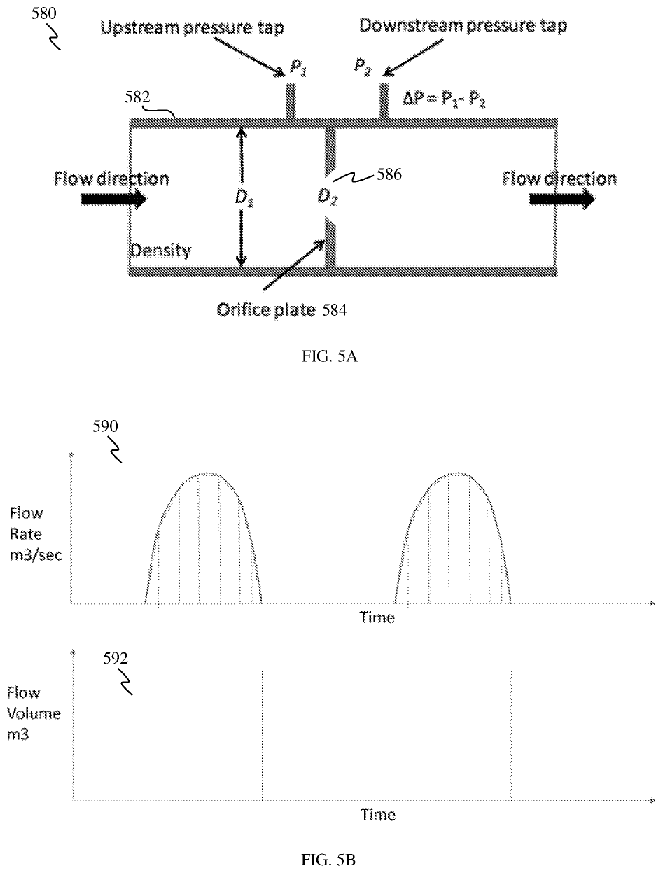

FIG. 5A shows a schematic diagram of a model 580 for flow rate calculation. The model 580 includes a simplified valve body 582, and an orifice plate 584 with an aperture 586. The formula for flow rate calculation may be as provided below:

q=(cD)×(π/4)×(D2\hat{ }2)×(2×(P1−P2)/ρ×(1−(D2/D1)\hat{ }4))\hat{ }½×a+b Equation (1),

where,
q is the flow rate in m³/s,
D1 is the valve inlet diameter (in m),
D2 is the valve outlet diameter (in m),
cD is the discharge coefficient, and is the area ratio between the outlet cross section area (A2) and the inlet cross section area (A1), i.e., cD=A2/A1,
P1 is the inlet pressure (in N/m²),
P2 is the outlet pressure (in N/m²),
ρ is the fluid density in kg/m³,
a and b are calibration parameters.

The fluid density value depends on the type of fluid/medium, and may change with temperature. The processing circuit (or smart valve board) may store the fluid density table for real time determination of the fluid density value. A user may configure the type of fluid to the system, and the smart relief valve may find the fluid density based on the temperature measurement, e.g., via the temperature sensor of the smart relief valve.

The flow rate calculation may involve the following steps:

Calibration parameters, a and b, may be determined based on tests with external flow meter, and configured to the smart valve. This may be done via cloud UI or local communication link. If done via cloud UI, the configuration may be sent down to the gateway, and then to the smart valve.

Configure the type of fluid/medium. This may be done via cloud UI or local communication link. If done via cloud UI, the configuration may be sent down to the gateway, and then to the smart valve.

The smart valve samples the inlet pressure, outlet pressure and temperature values from the corresponding sensors continuously.

Values for D1, D2, A1, A2 (and hence cD) are fixed values and may be stored in smart valve software.

The valve software (in the processing circuit) may determine the fluid density from the stored data table based on the current temperature and the configured medium type.

The valve software may then calculate the flow rate based on Equation (1) with the measured/stored input values for D1, D2, cD, P1, P2, ρ, a, b.

As temperature is measured, fluid characteristic differences under different temperatures may be taken into account in the flow rate calculation.

The relief flow volume may be calculated from the flow rate data. FIG. 5B shows an example of the flow rate and flow volume results 590, 592.

Referring to the flow rate results 590, it may be observed that the flow rate value starts to increase from 0 when relief starts and goes back to 0 when relief ends. The flow volume is the integral of the flow rate over time (or area under the flow rate curve). The flow rate data may be sent from the smart relief valve to the gateway/cloud at the end of relief. For easier understanding and as illustrated in FIG. 5B, the flow volume only accumulates within the same relief process and starts from 0 again for each relief. The calculation of the flow volume is an estimate, assuming straight line between adjacent flow rate data points.

The techniques disclosed herein may help to provide one or more of the following relief information, which may be useful in one or more industrial aspects and provides commercial value:

Relief timing;

Relief status;

Relief flow rate;

Relief flow volume;

Detection of spring deterioration;

Non-indication of relief at pre-set pressure.

As non-limiting examples, the techniques may be employed for one or more of the following.

Preventive Maintenance

The relief data may allow more in-time and cost-effective preventive maintenance. The relief timing and status may provide information on the system status, knowing if/when the relief happened enables the operation team to check and maintain the system.

Over time, the spring in the relief valve may deteriorate and its pressure may drop below the previously configured pre-set pressure. When the spring is in this condition, relief may likely happen earlier, before the pressure reaches the pre-set value. The smart relief valve of various embodiments may detect this condition and send a notification, for example, to a user so that check-up may be performed and/or maintenance may be performed to address the condition.

The opposite failure mode to spring deterioration is that the relief is not detected when the inlet pressure reaches the pre-set pressure. The smart relief valve of various embodiments may also detect this condition and send a notification, for example, to a user so that check-up may be performed and/or maintenance may be performed to address the condition. Such a condition may be due to environmental changes impacting spring pressure, error in pre-set configuration, pressure measurement error or other factors.

Detection of the spring deterioration and/or non-indication of relief at pre-set pressure are considerations for preventive maintenance. As discussed, the techniques disclosed herein may enable detection of anomalies in the relief spring and/or detection of anomalies in the relief status.

Safety

Reliable relief at the pre-set pressure is critical for safety, and detection of a malfunction of the relief valve is required to ensure that the system is safe. Further, when the fluid(s) or medium (or media) in the valve is hazardous, knowing the relief flow rate and relief flow volume may be required for system/environmental safety as well.

Big Data and Anomaly Detection

The relief data collected on the cloud may be used for big data analysis, for example, to identify trend and/or detect anomaly. The analysed insight may be used for maintenance, process improvement and more.

As described above, the techniques disclosed herein may measure outlet pressure in addition to the inlet pressure, and hence are able to use the outlet pressure to determine the relief state (i.e., valve open/close). Using the outlet pressure to determine relief state is deterministic and may be immune to or, at least, minimally affected by relief spring characteristic changes due to deterioration or other factors, and, hence, preferable to known techniques using outlet temperature which may be prone to errors introduced by relief spring deterioration and other variations that may happen to the valve over time/operation.

The techniques disclosed herein may provide a mechanism to (re-)calibrate relief preset pressure to the same or different pressure levels. Two non-limiting examples include calibrating to a different preset pressure level on-demand, and re-calibrating to the same preset pressure after relief spring anomalies are detected as recovery mechanism.

As compared to known methods, the techniques disclosed herein may provide software and logic that make use of the sensor data to provide functions and features such as preset calibration and spring deterioration detection.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An apparatus comprising:
a relief valve comprising:
an inlet pathway arranged to receive a medium flowing in the apparatus; and
an outlet pathway arranged for the medium from the inlet pathway to flow through at a relief state to relieve pressure in the apparatus;
an outlet pressure sensor arranged to determine an outlet pressure associated with the outlet pathway; and
a processing circuit configured to determine a status of the relief valve based on the outlet pressure.

2. The apparatus as claimed in claim 1, further comprising:
an inlet pressure sensor arranged to determine an inlet pressure associated with the inlet pathway,
wherein the processing circuit is configured to determine the status of the relief valve based on the outlet pressure and the inlet pressure.

3. The apparatus as claimed in claim 1, wherein, in response to determination that the outlet pressure is higher than a non-relief pressure associated with the outlet pathway at a non-relief state, the processing circuit is configured to determine that the relief valve is at the relief state as the status of the relief valve.

4. The apparatus as claimed in claim 2,
wherein the relief valve has a defined pressure corresponding to the relief state, and
wherein, in response to determination that the outlet pressure is higher than a non-relief pressure associated with the outlet pathway at a non-relief state and determination that the inlet pressure is less than the defined pressure, the processing circuit is configured to determine that there is an anomaly in the relief valve as the status of the relief valve.

5. The apparatus as claimed in claim 2,
wherein the relief valve has a defined pressure corresponding to the relief state, and
wherein, in response to determination that the outlet pressure is substantially same as a non-relief pressure associated with the outlet pathway at a non-relief state and determination that the inlet pressure is equal to or more than the defined pressure, the processing circuit is configured to determine that there is an anomaly in the relief valve as the status of the relief valve.

6. The apparatus as claimed in claim 1, further comprising a constricted section to moderate the flow of the medium in the outlet pathway for the outlet pressure sensor to determine the outlet pressure at the relief state.

7. The apparatus as claimed in claim 1, further comprising a temperature sensor arranged to determine a temperature associated with the inlet pathway.

8. The apparatus as claimed in claim 1, wherein the processing circuit is further configured to determine a time of occurrence of the relief state.

9. The apparatus as claimed in claim 1, wherein the processing circuit is further configured to determine a flow rate of the medium flowing through the outlet pathway at the relief state.

10. The apparatus as claimed in claims 9, wherein the processing circuit is further configured to, based on the determined flow rate, determine a flow volume of the medium flowing through the outlet pathway.

11. The apparatus as claimed in claim 1, wherein the relief valve comprises a spring-operated relief valve.

12. The apparatus as claimed in claim 1, wherein the processing circuit comprises a transmitter configured to transmit data indicative of the status of the relief valve.

13. A system comprising:
the apparatus as claimed in claim 12; and
a communications device communicatively coupled to the processing circuit of the apparatus to receive the data indicative of the status of the relief valve.

14. The system as claimed in claim 13, wherein the communications device is configured to, based on the data indicative of the status of the relief valve,
generate a notification corresponding to the status; and
transmit the notification to a user communications device.

15. A method comprising:
determining an outlet pressure associated with an outlet pathway of a relief valve of an apparatus, the relief valve comprising an inlet pathway arranged to receive a medium flowing in the apparatus, and the outlet pathway arranged for the medium from the inlet pathway to flow through at a relief state to relieve pressure in the apparatus; and
determining a status of the relief valve based on the outlet pressure.

16. The method as claimed in claim 15, further comprising:
determining an inlet pressure associated with the inlet pathway; and
wherein determining the status of the relief valve comprises determining the status of the relief valve based on the outlet pressure and the inlet pressure.

17. (canceled)

18. The method as claimed in claim 16,
wherein, in response to determination that the outlet pressure is higher than a non-relief pressure associated with the outlet pathway at a non-relief state and determination that the inlet pressure is less than a defined pressure corresponding to the relief state, determining the status of the relief valve comprises determining that there is an anomaly in the relief valve, or
wherein, in response to determination that the outlet pressure is substantially same as a non-relief pressure associated with the outlet pathway at a non-relief state and determination that the inlet pressure is equal to or more than a defined pressure corresponding to the relief state, determining the status of the relief valve comprises determining that there is an anomaly in the relief valve.

19. (canceled)

20. (canceled)

21. (canceled)

22. (canceled)

23. (canceled)

24. (canceled)

25. (canceled)

26. A processing device comprising a processor and a memory, the processing device being configured under control of the processor, to execute instructions in the memory to:
determine a status of a relief valve of an apparatus for relieving pressure based on an outlet pressure, wherein the relief valve comprises an inlet pathway arranged to receive a medium flowing in the apparatus, and an outlet pathway arranged for the medium from the inlet pathway to flow through at a relief state to relieve pressure in the apparatus, and wherein the outlet pressure is associated with the outlet pathway.

27. (canceled)

28. (canceled)

29. (canceled)

30. (canceled)

31. (canceled)

32. (canceled)

33. (canceled)

34. (Cancelled)

35. (Cancelled)

36. (canceled)

37. (Cancelled)

38. A computer program or a computer program product comprising instructions for implementing the method as claimed in claim 15.

39. A non-transitory storage medium storing instructions, which when executed by a processor cause the processor to perform the method as claimed in claim 15.
